(19) United States
(12) Patent Application Publication
(10) Pub. No.: US 2015/0377428 A1
(43) Pub. Date: Dec. 31, 2015

(54) LIGHT-EMITTING ELEMENT

(71) Applicant: SHENZHEN CRYSTAL RIVER OPTOELECTRONIC TECHNOLOGIES CO., LTD, Shenzhen (CN)

(72) Inventors: Wenjie Chen, Hangzhou (CN); Kai Su, Midland, MI (US); Michael Allen Stanga, Greer, SC (US); Yongyin Kang, Hangzhou (CN)

(21) Appl. No.: 14/316,658

(22) Filed: Jun. 26, 2014

(51) Int. Cl. F21K 99/00

(52) U.S. Cl. CPC F21K 9/56; F21K 9/90; F21Y 2103/003

(57) ABSTRACT

The present invention relates to a tubular-shaped optical conversion element suitable for use in a light-emitting device. The element includes a light source and at least one wavelength conversion layer containing materials such as phosphors or quantum dots in a silicone matrix. The element also contains thermally conductive additives dispersed in the silicone matrix that improve thermal conduction within the wavelength conversion layer. The tubular element can be manufactured by economical methods and in various shapes. The present invention is also related to a LED lighting device that includes a LED light source within a tubular-shaped shell. A curable silicone fluid can be used to fill the space between the LEDs and the tubular shell and provide efficient light coupling between the LED and the shell.

### CROSS REFERENCE TO RELATED APPLICATIONS

Priority is claimed to:

U.S. Provisional Patent Application Ser. No. 61/840,415 by W. Chen et al., entitled “LIGHT-EMITTING ELEMENT”, filed on Jun. 27, 2013, the disclosure of which is incorporated herein by reference.

### FIELD OF THE INVENTION

The present invention relates to a tubular-shaped optical conversion element suitable for use in a light-emitting device, wherein the element includes at least one light source, and one or more wavelength conversion layers. The wavelength conversion layer(s) contains materials such as phosphors or quantum dots, and thermally conductive additives dispersed in silicone.

### BACKGROUND OF THE INVENTION

Semiconductor light-emitting diodes (LEDs) are useful in many applications including solid state lighting devices. Such devices often strive to effectively replace incandescent or fluorescent light fixtures. Consequently, in some applications, LEDs are used to generate white light and it is often desirable to produce white light having a high color rendering index (CRI), which is a measure of how well the light accurately reproduces the colors of various objects in comparison with an ideal or natural light source. LED-based solid state lighting devices can have significant advantages relative to conventional light sources including longer lifetimes, smaller size, and greater energy efficiency, however, they are often more expensive.

The quality of light produced by a light source can be objectively specified by its chromaticity. For example, white light can be defined in terms of its whiteness, yellowness, or blueness, and its warmth or coolness in terms of its chromaticity. Chromaticity is defined by the correlated color temperature (CCT), which is measured in degrees Kelvin. The chromaticity of white light source is usually between 2,000 K and 8,000 K. A color temperature around 2,000 K is considered warm and becomes cooler as the temperature increases. Thus, white light having a color temperature at the higher range is considered “cool white” and has a stronger blue component. White light having a color temperature in the lower range is considered “warm white” and has a greater red component. Daylight has a color temperature near 5,000 K. Solid state lighting devices have been developed that produce light in a wide range of color temperatures.

There are numerous ways to produce white light using LEDs. A fundamental way is to combine LEDs emitting light of different colors, for example, by combining LEDs that emit blue, green, and red light so that the color mixture provides a broad spectrum corresponding to white light. However, because LEDs emit light having a relatively narrow half-band width, this is often not the most efficient way to produce white light.

A more common way to produce white light is to employ LEDs in combination with one or more “wavelength conversion materials” such as a phosphor material. Wavelength conversion materials absorb light having a first wavelength and emit (convert) at least a portion of that light into light having a second wavelength that is longer than the first wavelength (lower in energy). For example, a blue light-emitting LED can be used in combination with a phosphor that absorbs a portion of the blue light and emits yellow light. The combination of the unabsorbed blue light from the LED and the yellow emission from the phosphor can provide white light.

One way to combine an LED with a wavelength conversion material is to coat the material on the surface of the LED. For example, a mixture of a yellow phosphor and a resin can be coated on an LED that emits blue light. An alternative approach is to provide the conversion material spaced apart from the LED. For example, a phosphor/resin combination can be coated on a substrate, often referred to as a lens, which is located at a distance from the LED. This approach is frequently referred to as using a remote phosphor. One advantage of using a remote phosphor is that any heat generated by the LED is less likely to impact or degrade the performance of the phosphor over time.

Heat is also generated by the wavelength conversion process. For example, phosphors are not completely efficient at converting light and small amounts of thermal energy are released into the phosphor layer. In certain cases, the heat can cause degradation of the phosphor or the matrix in which the phosphor is dispersed. This can cause a shift in color characteristics with time.

Many types and shapes of lighting devices employing LEDs and wavelength conversion layers have been described previously. For example, U.S. Patent Application No. 2012/0007492 discloses a semiconductor light emitting apparatus that includes an elongated hollow wavelength conversion tube. The tube wall includes wavelength conversion material, such as phosphor, dispersed therein. The elongated hollow wavelength conversion tube includes first and second opposing ends. A first semiconductor light emitting device is oriented adjacent the first end to emit light inside the tube. A second semiconductor light emitting device is oriented adjacent the second end to also emit light inside the tube. However, despite the progress made in the area of solid state lighting, there is still a need for new devices designed to emit light more efficiently and that can be manufactured by economical methods in order to reduce the cost of each unit.

### Problem to be Solved

A common way to construct a solid state light-emitting device is to place an LED in a reflector cup and to place a phosphor-containing lens at the top of the reflector cup and spaced apart from the LED. This approach suffers from the fact that not all the light emitted by the LED is likely to pass through the lens since some is lost due to internal absorption. Also, the light emitted by such a device is directional, that is, it does not emit light in all directions like a common tungsten light bulb. Thus, it would be desirable to develop light-emitting devices that more efficiently emit all the light that is generated and are capable of emitting light that is omnidirectional. It would also be highly desirable to make such devices cost-effective to manufacture in order to compete with conventional lighting options. Further, it would be desirable to minimize any heat that is present in a phosphor containing layer, in order to minimize degradation of the layer.

In the traditional process of phosphor packaging, there are several disadvantages that need to be addressed. Firstly, if a phosphor is coated with a carrier such as silicone, during the coating process the phosphor particles can settle, resulting in an uneven particle distribution. This can impact the optical performance and the uniformity of light produced. A second concern is that it is often difficult to obtain a uniform thickness of the phosphor layer. This can also lead to non-uniform light production. A third concern is that both the chip and the phosphor generate heat when in operation, therefore, reducing the efficiency of the LED device. Improving LED efficiency and the uniformity of LED light and reducing the cost of LED lighting devices is a key challenge for the solid state lighting industry.

### SUMMARY OF THE INVENTION

The present invention relates to a tubular-shaped optical conversion element suitable for use in a light-emitting device. The element includes a light source and at least one wavelength conversion layer. The wavelength conversion layer includes phosphors or quantum dots in a matrix material that includes silicones. The element also contains thermally conductive additives dispersed in silicone that improve thermal conduction within the wavelength conversion layer. The tubular element can be manufactured by economical methods and in various shapes.

The present invention is also related to LED lighting device that includes a LED light source within a tubular-shaped shell. A curable silicone fluid can be used to fill the space between the LED and the tubular shell and provide efficient optical coupling between the LED and the shell. In one embodiment the light source includes a string of light-emitting diodes each having a support. Optionally, the support is transparent such that light is emitted both above and below the diode. In a further embodiment, the shell and wavelength conversion layer are formed by extrusion molding. In some embodiments, the shell includes more than one wavelength conversion layer, wherein the multiple layers are formed by co-extrusion molding. In other embodiments, the shell includes at least one substrate in addition to the wavelength conversion layer(s). Preferably the substrate is transparent; however, in certain embodiments the substrate is not transparent. Optionally, the substrate(s) can be coated with additional wavelength conversion materials. In a preferred embodiment, the element produces white light having a high color rendering index.

### Advantageous Effect of the Invention

The present invention includes several advantages, not all of which are incorporated in a single embodiment. The main advantage of the disclosed design in terms of function is to produce a LED lighting device using a preformed tube and blue LED emitters. In certain embodiments, the device can emit light in all directions. The phosphor tube incorporates phosphors and thermally conductive fillers which can effectively dissipate the heat and improve the lifetime of the device. The tube can be manufactured using economical methods.

### BRIEF DESCRIPTION OF THE DRAWINGS

FIG. 1 represents schematically one embodiment of a tubular shaped element.

FIG. 2 shows schematically a cross-section of one embodiment of a tubular shaped element.

FIGS. 3A and 3B show schematically cross-sections of some embodiments of a tubular shaped element.

FIG. 4 shows schematically a cross-section of one embodiment of a tubular shaped element having multiple wavelength conversion layers.

FIG. 5 shows schematically a cross-section of one embodiment of a tubular shaped element having a substrate.

FIG. 6 shows schematically a cross-section of one embodiment of a tubular shaped element having a substrate coated with a wavelength conversion material.

FIG. 7 shows schematically a disc containing a thermally conductive additive and wherein the temperature is measured at the top (T1) and bottom (T2) when heat is applied.

FIG. 8 shows the spectra output of discs containing various thermally conductive additives.

### DETAILED DESCRIPTION OF THE INVENTION

The invention provides a light-emitting element that includes a light source. Preferably the light source has an emission maximum in the range of about 300 nm to about 500 nm; thus, for example, the light source can emit UV light or blue light. The light source can include a single component or multiple components that generate light. In a preferred embodiment, the light source includes at least one light-emitting diode (LED), for example, the light source can be a single LED or multiple LED chips. LED chips are well-known in the art, and are often made by depositing layers of semiconductor material on a substrate wafer using an epitaxial method, such as metal-organic chemical vapor deposition or MOCVD. The various layers are doped to form p-type and n-type materials that result in the creation of an electric field at their interface (p-n junction). When a sufficient voltage is applied across a p-n junction, current flow is initiated and sustained by the recombination of holes and electrons. Upon recombination, energy approximately equal to the bandgap energy of the junction is released. For III-V semiconductor materials such as GaAs, InP, GaN, etc., the released energy is in the form of light. The InGaN—GaN system is often employed for wavelengths from ˜365 (ultra-violet, UV) to 550 (yellow-green) nm. In one desirable embodiment, the light source includes at least two LEDs and preferably greater than two LEDs. For example, the light source can include a string of LEDs. In one embodiment, the LEDs emit ultra-violet or blue light in the range of 300 nm to 500 nm. In one suitable embodiment, the LEDs have a maximum emission in the range from about 400 nm to about 500 nm and preferably in the range of about 430 nm to about 490 nm, and most preferably 430 to 470. In a further embodiment, the light source includes multiple LEDs that emit at the same wavelength, for example, the LEDs may all emit blue light. In an alternative embodiment, the light source includes multiple LEDs, wherein all the LEDs do not emit at the same wavelength. For example, some of the LEDs emit blue light and some emit red light.

An LED is commonly mounted on a support. In one preferred embodiment, the LED(s) is mounted on a transparent support, which enables the LED to emit light both above and below the support. This enables light to be emitted from all sides of the LED. For purposes of this disclosure, the term transparent also includes materials that are translucent or semitransparent. In certain embodiments, a transparent material allows at least 50% of the light to pass through it, desirably at least 75% of the light, and preferably at least 90% of the light to pass through it. In other embodiments, the LED(s) is mounted on a support that is not transparent.

The element includes a transparent tubular-shaped shell surrounding the cavity. The shell can have various shapes including, for example, a straight tube, a curved tube, a spiral shape, semicircle shape, or a twisted shaped tube. The surface of the shell can be smooth or textured. The surface can include images or lettering.

The light source, as described above, is present in the cavity within the shell such that the light source is optically coupled to the shell. The cavity also includes wires for supplying electric power to the LED(s). In some embodiments the cavity includes an inert gas such as Helium. In certain embodiments, the cavity includes a thermoplastic resin such as silicone derivatives that can be cured. For example, LED(s) can be placed in the cavity and then organopolysiloxanes, which include reactive groups that can be cross-linked in the presence of a catalyst, can be added to the cavity and cross-linked to form a resin.

The shell includes at least one wavelength conversion layer. In one preferred embodiment, the wavelength conversion layer comprises phosphor particles and a matrix material such as silicone. In certain embodiments the phosphor particles are uniformly distributed throughout the wavelength conversion layer and in other embodiments the particles are non-uniformly distributed. In another suitable embodiment, the wavelength conversion layer includes quantum dots. In a further embodiment the layer includes both quantum dots and phosphor particles.

Semiconductor nanocrystals, often referred to as quantum dots, were discovered in the 1980's and have unique properties. They are well-known for their use in light-emitting devices. In certain embodiments the quantum dots, when present, include low reabsorbing semiconductor nanocrystals as described in Patent Application WO2012135744, incorporated herein by reference in its entirety.

In a further embodiment the shell includes a thermal-conductive additive such as a metal oxide, for example, aluminum oxide. The additive aids in conducting and removing any heat that is present in the shell during operation of the element.

In one desirable embodiment, the shell includes a wavelength conversion layer formed by extrusion molding. Extrusion molding is a well-known process for forming large numbers of objects in an economical manner. In some embodiments the shell constitutes multiple concentric wavelength conversion layers, each of which is formed by extrusion molding.

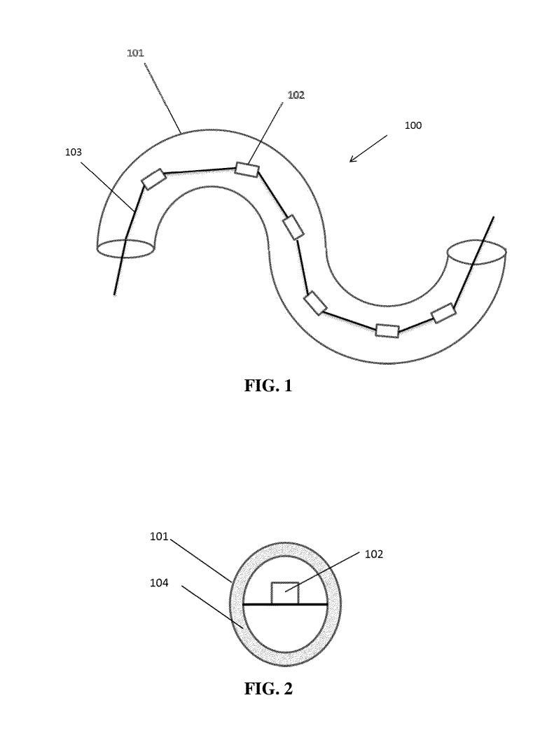

FIG. 1 shows a schematic representation of one embodiment of a tubular element (100) including a tubular shell 101 and LEDs (102) inserted in the shell and wherein the LEDs are connected to a power source by wires 103. The support for the LEDs and the power source are not shown. FIG. 2 shows a schematic representation of a cross section of the tubular element (100) including the shell 101, wavelength conversion layer 104, and LED (102). In this embodiment, the shell contains only the wavelength conversion element and is formed by extrusion molding.

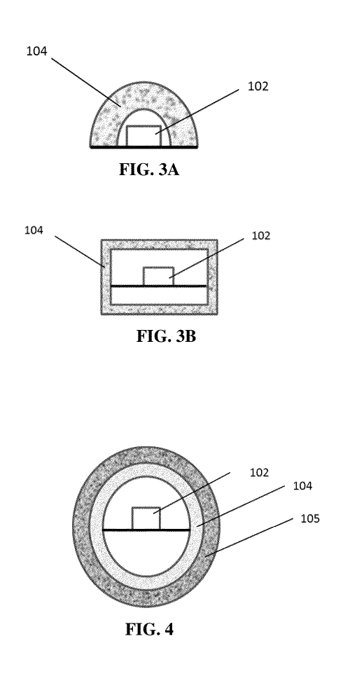

In some embodiments, the cross section of the tubular shell is circular; however, the cross section can have other shapes such as polygonal or semicircular, provided the shell is generally tubular in shape with an internal cavity. For example, FIG. 3A shows schematically an element having a semicircular cross section including a tubular shell 101, wavelength conversion layer 104, and LED (102) inserted in the shell. FIG. 3B is a schematic depiction of an element having a rectangular cross-section. In a preferred embodiment, the cross-section is circular in shape.

In a further embodiment, more than one conversion layer is present. For example, two or more layers can be present forming concentric tubes. The concentric tubes can be contiguous or spaced apart. FIG. 4 shows a schematic representation of the cross-section of an example of this embodiment wherein a the tubular shell includes a first wavelength conversion layer 104 corresponding to a first phosphor, for example, a phosphor that emits red light, and wherein the phosphor is present in a silicone matrix. A second wavelength conversion layer 105 corresponding to a second phosphor such as a yellow phosphor, also in a silicone matrix, surrounds the first phosphor layer. Both layers can be formed by co-extrusion. One or more LEDs (102) are present in the center of the shell.

By way of example, an extruded wavelength conversion layer can be prepared by combining phosphor particles with a thermoplastic resin to form a composite. The composite can be extruded in the shape of a tube, and cured. An especially useful composite includes phosphor particles, silicone fluid, silicone rubber precursors, a curing agent, and a thermally conductive filer. Silicones are high-molecular-weight polymers based on silicon atoms bonded to oxygen atoms, which are cross-linked by organic radicals. Variations in the organic radicals, the chain length, and the method of cross-linking adjacent chains determine the properties of the final material, which can be a fluid, a resin, or a rubber. Silicone fluids are clear high-boiling liquids. Silicone rubbers are high-molecular weight polymers having very long chain lengths.

In a preferred embodiment, the composition of tubular shaped wavelength conversion layer of the present invention includes: Component A, high consistency silicone rubber precursors; Component B), a thermally conductive additive; Component C, at least one phosphor material; Component D, a curing agent; and Component E, silicone fluid. There are no special restrictions on the curing mechanism of the composition. Preferably, the composition can be cured by hydrosilylation, or free-radical reaction by using organic peroxide. The composition can be typically cured at a temperature of 100-300 C.° for 10-90 s, the preferable curing condition is 200-250° C. for 40-60 s. After curing, the composite is often post-cured at a temperature 150-250° C. for 1-5 h, the preferable curing condition is 180-220° C. for 1.5-2.5 h.

Suitable silicone rubber precursors include a combination of organopolysiloxanes having a first reactive group and organopolysiloxane having a second reactive group. Upon heating in the presence of a curing agent (catalyst) cross-linking of the organopolysiloxane occurs (the first reactive group reacts with the second reactive group) forming a silicon rubber matrix. Desirable reactive groups include, but are not limited to, unsaturated groups (for example, alkenyl groups) and silicon groups bonded to hydrogen (—Si—H groups). The polymers may have multiple reactive groups. In one desirable embodiment, reactive groups are present at the terminal end of the polymer. In an alternative embodiment, high consistency silicone rubber can be prepared by polymerizing monomers.

Suitable organopolysiloxanes are exemplified by the following compounds: dimethylvinylsiloxy group terminated polydimethylsiloxane, methylphenylvinysiloxy group terminated polydimethylsiloxane, dimethylvinylsiloxy group terminated a copolymer of dimethylsiloxane and methylphenylsiloxane, dimethylvinylsiloxy group terminated a copolymer of methylvinylsiloxane and dimethylsiloxane, trimethylsiloxy group terminated a copolymer of methylvinylsiloxane and dimethylsiloxane, dimethylvinylsiloxy group terminated a copolymer of methyl(3,3,3-trifluoropropyl)siloxane and dimethylsiloxane, dimethylvinylsiloxy group terminated a copolymer of methyl(3,3,3-trifluoropropyl)siloxane and methylvinyl siloxane, trimethylsiloxy group terminated a copolymer of methyl(3,3,3-trifluoropropyl)siloxane and methylvinyl siloxane, Trimethylsiloxy group terminated a copolymer of methylhydridesiloxane and dimethylsiloxane, or a mixture of two or more of above. There are no special restrictions with regard to the amount of Component A.

But it may be recommended that the amount, in terms of mass %, is range of 0.01 mass % to 99.9%, preferably within the range of 20 to 90 mass %, and more preferably within the range of 60 to 80 mass %.

When the composition of the tubular shaped wavelength conversion layer of the present invention is cured by a hydrosilylation reaction, it is recommended that the Component A be comprised of an organopolysiloxane with an average of 0.05-0.5 mol. % of methylvinyl siloxane unit in one molecule, preferably an organopolysiloxane that contains 0.1-0.4 mol. % of methylvinyl siloxane unit in one molecule, and even more preferably an organopolysiloxane that contains in one molecule on range of 0.15 to 0.35% methylvinyl siloxane unit, also including an organopolysiloxane with an average of 0.04-0.45 mol. % of methylhydride siloxane unit in one molecule, preferably an organopolysiloxane that contains 0.1-0.35 mol. % of methylhydride siloxane unit in one molecule, and even more preferably an organopolysiloxane that contains in one molecule on range of 0.15 to 0.35% methylhydride siloxane unit.

There are no special restrictions with regard to the Component A in the composition of the present invention which is cured by a free-radical reaction by using organic peroxide, but the preferable one is an organopolysiloxane that contains at least 0.1 mol. % methylvinyl siloxane unit in one molecule.

Component B includes a thermally conductive additive that is used to improve heat conduction in the wavelength conversion layer. The presence of this component allows any heat that is present in the conversion layer to be conducted out of the layer and away from the phosphor. This can increase the lifetime of the phosphor material and other components in the layer. In certain embodiments, it is preferable that the additive has a thermal conductivity that is at least 10% greater, desirably at least 25% greater, and preferably at least 75% greater than the average thermal conductivity of the wavelength conversion layer without the additive. In certain embodiments, the additive has a thermal conductivity that is greater than 1.0 Wm⁻¹K⁻¹ and desirably greater than 10 Wm⁻¹K⁻¹. Examples of suitable thermally conductive additives include: metal oxides such as aluminum oxide, magnesium oxide, and titanium oxide; metal nitrides such as aluminum nitride, and silicon nitride; glass and quartz, or mixtures of these materials. In one suitable embodiment, the thermal additive includes metal oxide particles and wherein the particles are at a level of less than 20% of the layer by weight, or suitably at a level less that 10%, or even 5% or less. In another desirable embodiment, the thermal additive includes a transparent or translucent material, for example, glass or quartz. This can minimize any loss in luminance due to the optical properties of the additive. The additive particles can have various shapes, for example, spherical, needle-shaped, rod-shaped, disc-shaped or irregular-shaped particles. In certain embodiments, the particle size is within the range of 0.1 to 200 μm, and desirably within the range of 0.5 to 50 μm. In some embodiments, the particle size of the additive is less than 100 nm, and even less than 50 nm. Suitably, the amount of thermal additive within the wavelength conversion layer is typically 1 to 80 weight %, and often 5 to 50 weight % and is some cases, as described previously, less than 20 weight %.

Component C incudes a phosphor that is used to impart wavelength conversion function to the phosphor/silicone tubing, for example, a YAG phosphor. Further non-limiting examples of useful phosphors include: Y₃(Al,Ga)₅O₁₂:Ce; ZnS:Cu, Al; ZnS:Cu,Au,Al; Zn₂SiO₄:Mn,As; Sr₃SiO₅:Eu; Y₂OS:Tb, Y₂SiO₅:Tb; BaMgAl₁₀O₁₇:Eu Mn; SrAlO₄:Eu,Dy; (YGdCe)₃Al₅O₁₂:Eu; Sr₄Al₁₄O₂₅:Eu; (Ce, Tb)MgAl₁₁O₁₉; or (La, Ce, Tb)PO₄, LaPO₄:Ce,Tb, (La,Ce,Tb)PO₄, (La,Ce,Tb)PO₄:Ce,Tb; YAG:Ce and mixtures thereof. Examples of useful phosphors include those described in U.S. Pat. No. 5,998,925 to Yoshinori Shimizu et al. and U.S. Pat. No. 7,750,359 to Narendran et al., both incorporated herein by reference in their entirety. In one preferred embodiment, suitable phosphor materials include the YAG phosphor (YAG:Ce³⁺), or a mixture having at least two components and including YAG:Ce³⁺ mixed with Ba₃MgSi₂O₈:Eu,Mn; Ca(Mo,W)O₄:Eu,Sm; (Sr,Ca)S:Eu; Sr₂Si₅N₈:Eu; (Ca,Sr)AlSiN₃:Eu; or (Na,Li)Eu(W,Mo)₂O. In a further embodiment, the concentration of the phosphor in the wavelength conversion layer is between 0.01%-99.9% by weight.

The Component D includes a catalyst or curing agent, which is used to cure the composition of the present invention. For example, a hydrosilation catalyst that promotes the cross-linking of Component A. Suitable curing agents include platinum-type catalysts and the organic peroxide-type catalysts. Specially, when the composition is cured with a platinum-type catalyst, it can be exemplified by the following compounds: chloroplatinic acid, an alcohol solution of chloroplatinic acid, platinum-olefin complex, platinum-alkenyl-siloxane complex, and platinum-carbonyl complex. The platinum-type catalyst should be used in an amount required for curing the composition of the present invention. In particular, in terms of mass, it should be added in an amount of 0.1 to 1000 ppm, and preferably 0.5 to 500 ppm of metallic platinum per Component A. If the amount of the catalyst is added below the recommended level, there will be not completely cured, and if, on the other hand, it is added in an amount exceeding the recommended level, the composition may be cured during the extrusion process, which could cause the extruded tube to be non-uniform.

When the composition is cured by a free-radical reaction with use of an organic peroxide compound, the Component D can be exemplified by the following compounds: benzoyl peroxide, dicumyl peroxide, 2,5-dimethyl bis(2,5-t-butylperoxy) hexane, di-t-butylperoxide, and t-butyperbenzoate. The organic peroxide should be used in sufficient for curing, in particular, in an amount of 0.5 to 3 parts by mass per 100 parts by mass of the Component A.

Component E includes an organipolysiloxane that significantly improves the dispersion characteristics of the other components. The viscosity of Component E should be choose in a specific range, in particular, it should be range of 200 to 80000 mPa·s, preferably within the range of 3000 to 50000 mPa·s, and more preferably within the range of 5000 to 20000 mPa·s. If the viscosity of the organipolysiloxane below the recommended level, there will be lead to settling of the Component B and C, and if, on the other hand, if the viscosity of the organipolysiloxane exceeds the recommended upper limited, there will be remarkably lower the dispersity of Component B and Component C. There are no special restrictions of the molecule structure of the aforementioned organipolysiloxane, which may have a linear-chain, branched-chain, partially branched linear or dentritic molecular structure. Suitably, the organipolysiloxane (Component C) is present in a range of 0.01 to 30 mass %; preferably within the range of 1 to 20 mass %, and more preferably within the range of 5 to 15 mass %.

In one desirable embodiment, a method for preparing a light-emitting element includes combining the following components, with mixing, to form a composite: Component A, organopolysiloxane having reactive groups present; Component B, a thermally conductive additive; Component C corresponding to at least one phosphor material; Component D, a curing agent; and Component E, an organopolysiloxane that aides dispersion. The composite is then extruded in the shape of a tube having an internal cavity and, thus, affords a shell for the light-emitting element. The shell is then cured by heating at a high temperature, which causes crosslinking of the reactive organopolysiloxanes to form a high consistency silicone rubber matrix. After curing, the shell is post-cured by heating it at a second lower temperature for an extended period of time. In one suitable embodiment, Components B, C, and E are combined and mixed initially and the Components A and D are then added with mixing to form the composite. In a further embodiment, the first mixture includes Component C and Component E in the ratio of (1):(x) by weight, wherein x is a value between 0.2 and 1.0. In some embodiments the shell is cured between 200 to 300° C. for a suitable period of time such as 10 to 90 seconds, or preferably from 40 to 60 seconds. The post cure treatment is typically at a temperature of 100 to 250° C. for 1 to 5 hours or preferably 1.5 to 2.5 hours.

The method described above affords a wavelength conversion layer that includes a silicone matrix containing at least one phosphor material and a thermally conductive additive. In addition to forming a tubular shaped shell, the method is also useful for preparing various shaped lenses that can be used with a light source such as an LED as known in the literature. For example, instead of extruding the composite in the shape of a tube, one could extrude it in the shape of a more conventional lens such as an oval or circular shape. Examples of useful lens shapes include biconcave, plano-convex, plano-concave, and convex-concave.

In certain embodiments, two or more concentric wavelength conversion layers can be formed by co-extrusion. For example, a first composite can be formed, as described above, containing a first phosphor (for example, a phosphor that emits red light when excited). A second composite can be formed, also, as described above, containing a second phosphor (for example, a phosphor that emits yellow light when excited). The first and second composites can be co-extruded simultaneously to form a tubular shaped shell having concentric layers containing the first phosphor material in the inner layer and the second phosphor materials in the outer layer.

As described above, the shell includes at least one wavelength conversion layer. In one embodiment, the wavelength conversion layer constitutes the entire shell. In alternative embodiments, the shell includes one or more tubular shaped substrates. Desirably, the substrate is transparent; however, in certain embodiments the substrate(s) is not transparent. Examples of suitable substrate materials include glass and polymers such as polycarbonate, acrylic, methacrylic, polyvinyl chloride, polypropylene, polyethylene, and silicone rubber, or other polymeric materials. The substrate can be ridged or flexible. In some embodiments the tubular shaped wavelength conversion(s) layer is located on the interior of the substrate and facing the cavity and in other embodiments it is located on the exterior of the substrate.

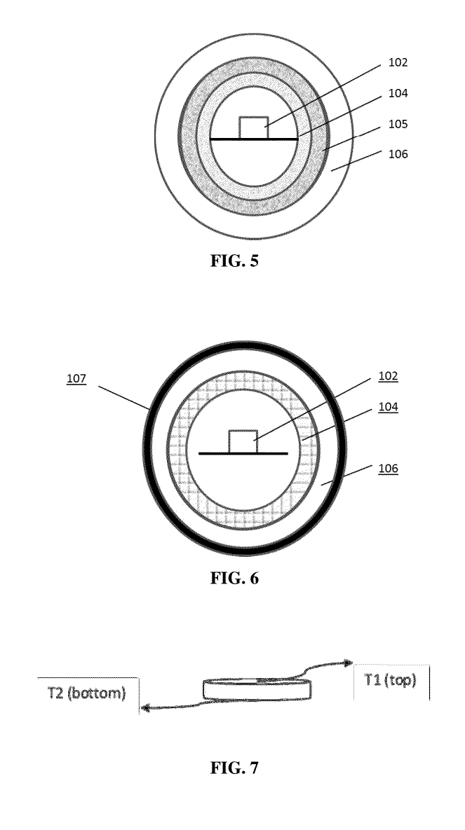

FIG. 5 represents schematically a suitable embodiment and shows the cross-section of a tubular shell that includes a first wavelength conversion layer 104 containing a first phosphor, for example, a phosphor that emits red light, in a silicone matrix. A second wavelength conversion layer 105 containing a second phosphor such as a yellow phosphor, also in a silicone matrix, surrounds the first phosphor layer. Both layers can be formed by co-extrusion and are placed inside an outer tubular shaped substrate, 106. Thus, the shell includes multiple concentric tubes. The substrate 106 corresponds to a transparent polymer and can support and protect the wavelength conversion layers. One or more LEDs (102) are present in the center of the element.

In other embodiments, a tubular-shaped substrate is used, as described above, to support at least one wavelength conversion layer formed by extrusion molding and, in addition, the substrate is coated with at least one layer of a second wavelength conversion material. FIG. 6 illustrates schematically an example of one such embodiment and depicts a cross-section of an element that includes a shell containing a wavelength conversation layer 104 formed by extrusion molding and including a first phosphor. A substrate 106 is coated with a layer, 107, containing a second phosphor in a silicone matrix. One or more LEDs 102 is present within the shell. In other suitable embodiments, the interior of the substrate is coated with wavelength conversion material instead of the exterior. In still further embodiments, both the interior and exterior surfaces of the substrate can be coated with the same or different wavelength conversion materials.

An efficient way of coating the substrate can be described by the following non-limiting example. Phosphor particles and silicone fluid are mixed in a ratio of (1):(x) by weight, wherein x is a value between 0.2 and 1.0 and placed in a container. Tubing made of polymeric material is passed through the container, which coats the tubing with the phosphor/silicone mixture. The phosphor coated tubing is them cured at a temperature of 100 to 300° C. for 10 to 60 min. and preferably from 15 to 30 min. The tubing is then subjected to a post cure at 150 to 250° C. for 1 to 5 h, and preferably for 1.5 to 2.5 h. The cured tubing can be optionally coated with a second layer of a second phosphor/silicone mixture, by repeating the process described above and wherein the second mixture contains a different phosphor then the first mixture. In this way, multiple phosphor layers can be formed on the substrate.

In some embodiments, the tubular shaped shell has a tubing wall with a thickness that is between 0.01-1 mm, and the inner diameter is between 0.5-5 mm. In certain embodiments, optical elements such as a reflector, minor, or lens may be provided to direct the light inside the tubular element.

In one suitable embodiment, the shell or wavelength-conversion layer can include light diffusers or light scatterers. Non-limiting examples of light scatterers include small particles composed of glass, polymers, and metal oxides such as TiO₂, SiO₂, and BaSO_{4.}

Inserting one or more LEDs attached to a power source into the tubular-shaped shell described above forms a light-emitting element. When the LEDs are supplied with power they emit primary light, which passes through the wavelength conversion layer(s) present in the shell. The wavelength conversion layer(s) can convert all or a portion of the primary light to secondary light having a longer wavelength. The secondary light and any unabsorbed primary light exits the shell. By using LEDs that include a transparent support, the element can emit light in all directions, thus, affording 360° of illumination. By way of example, LEDs emitting blue light can be placed in a tubular shell, wherein the shell includes a wavelength conversion layer having a red phosphor and a yellow phosphor present. One skilled in the art can adjust the LED output and the phosphor levels such that light emitted from the element includes blue, red and yellow components that combine to provide white light. As is known in the art, many other combinations of LEDs and phosphors can be used to produce white light. In a preferred embodiment, the element emits light having a high color rendering index. Also, of course, by suitable choices of LEDs and phosphor, the element can emit various colored lights other than white.

The invention and its advantages can be better appreciated by the following examples.

### EXAMPLES

The following components were used in the inventive and comparative examples:

Component A1: Dimethylvinylsiloxy group terminated a copolymer of methylvinylsiloxane and dimethylsiloxane (content of MeViSiO unit=0.25 mol. %);

Component A2: Trimethylsiloxy group terminated a copolymer of methylvinylsiloxane and dimethylsiloxane (content of MeViSiO unit=0.20 mol. %);

Component A3: Trimethylsiloxy group terminated a copolymer of methylvinylsiloxane and dimethylsiloxane (content of MeViSiO unit=0.15 mol. %);

Component A4: Trimethylsiloxy group terminated a copolymer of methylhydridesiloxane and dimethylsiloxane (content of MeHSiO unit=0.23 mol. %);

Component B1: Spherical alumina oxide powder with BET specific surface of 0.5 m²/g and with average particle size of 10 μm;

Component B2: Spherical alumina nitride powder with BET specific surface of 0.5 m²/g and with average particle size of 5 μm;

Constituent B3: Spherical silicon carbide powder with BET specific surface of 0.5 m²/g and with average particle size of 5 μm;

Constituent B4: Spherical Glass bead with average particle size of 150 μm;

Component C1: Y₃(Al,Ga)₅O₁₂:Ce;

Component C2: (Sr,Ca)S:Eu; Sr₂Si₅N₈:Eu;

Component C3: Ba₃M_{g}Si₂O₈:Eu,Mn;

Component D1: complex of platinum and 1,3-divinyl-1,1,3,3-tetramethyldisiloxane with 0.5 mass % of metallic platinum;

Component D2: 2,5-Dimethyl bis(2,5-t-butylperoxy)hexane (Concentration is 50 mass %);

Component E1: Dimethylvinylsiloxy group terminated polydimethylsiloxane, Viscosity=5000 mPa·s;

Component E2: Dimethylvinylsiloxy group terminated polydimethylsiloxane, Viscosity=10000 mPa·s.

### Comparison of Thermally Conductive Additives

### Comparative Example C-1

### No Thermally Conductive Additive

Constituent C1 (0.2 g) and 0.02 g of Constituent C2 were dispersed in 0.9 g of Constituent A1 and of 0.9 g of Constituent A4 to from a mixture. D1 (0.015 g) was then dispersed in the mixture. A portion of the mixture (1.5 g) was ejection molded into the shape of a disc and cured at a temperature 150° C. for 10 min. This afforded a 2 mm thick disc.

### Inventive Example I-1

### 5 wt. % Al₂O₃

Constituent C1 (0.2 g), 0.02 g of Constituent of C2 and 0.1 g of Constituent B1 were dispersed in 0.85 g of Constituent A1 and 0.85 g of Constituent A4 to afford a mixture. D1 (0.015 g) was then dispersed in the mixture. A portion of the mixture (1.5 g) was ejection molded into the shape of a disc and cured at a temperature 150° C. for 10 min. This afforded a 2 mm thick disc.

### Comparison Example C-2

### 20 wt. % Al2O3

Constituent C1 (0.2 g), 0.02 g Constituent of C2 and 0.4 g of Constituent B1 were dispersed in 0.7 g of Constituent A1 and 0.7 g of Constituent A4 to form a mixture. D1 (0.015 g) was then dispersed in the mixture. A portion of the mixture (1.5 g) was ejection molded into the shape of a disc and cured at a temperature 150° C. for 10 min. This afforded a 2mm thick disc.

### Inventive Example C-3

### 20 wt. % AlN

Constituent C1 (0.2 g), 0.02 g of Constituent C2 and 0.4 g of Constituent B2 were dispersed in 0.7 g of Constituent A1 and 0.7 g of Constituent A4 to form a mixture. D1 (0.015 g) was then dispersed in the mixture. A portion of the mixture (1.5 g) was ejection molded into the shape of a disc and cured at a temperature 150° C. for 10 min. This afforded a 2mm thick disc.

### Inventive Example C-4

### 20 wt. % SiC

Constituent C1 (0.2 g), 0.02 g Constituent of C2 and 0.4 g of Constituent B3 were dispersed in 0.7 g of Constituent A1 and 0.7 g of Constituent A4 to form a mixture. D1 (0.015 g) was then dispersed in the mixture. A portion of the mixture (1.5 g) was ejection molded into the shape of a disc and cured at a temperature 150° C. for 10 min. This afforded a 2 mm thick disc.

### Inventive Example I-2

### 20 wt. % Glass Beads

Constituent C1 (0.2 g), 0.02 g of Constituent C2 and 0.4 g of Constituent B4 were dispersed in 0.7 g of Constituent A1 and 0.7 g of Constituent A4 to form a mixture. D1 (0.015 g) was then dispersed in the mixture. A portion of the mixture (1.5 g) was ejection molded into the shape of a disc and cured at a temperature 150° C. for 10 min. This afforded a 2 mm thick disc.

The thermal conduction of discs I-1, I-2, and C-1 through C-4 was measured by heating one surface of the disc to 150° C. (T₁), and measuring the temperature (T₂) of the opposite surface of the disc (see FIG. 7). The difference in temperature between the two surfaces (ΔT=T₁−T₂), is a measure the thermal conductivity. A smaller difference, ΔT, corresponds to better thermal conduction. The testing results are reported in Table I.

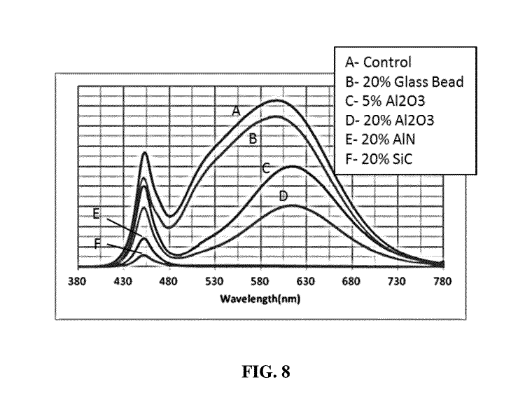

The optical performance of each disc was measured by placing the disc in a device having an LED that emits blue light (λp=455 nm, Φ=116 LM with CIE xy chromaticity coordinates corresponding to (0.1514, 0.0284). The disc was spaced apart from the LED and irradiated with blue light. The light output (φ) of the device was measured for each disc and the results are reported in Table I. Light output spectra of the 6 discs are shown in FIG. 8.

TABLE I

| | Thermal | Additive | | | Delta | ΔT | Relative −ΔT |
|---|---|---|---|---|---|---|---|
| Example | Additive | Size | Composition | Φ(lm) | Φ(lm) | (° C.) | (° C.) |
| C-1 | none | — | 0.2 g C1, 0.02 g C2, 0.9 g A1, | 487.9 | — | 65 | — |
| | | | 0.9 g A4, 0.015 g D1, 2 mm, | | | | |
| I-1 | 5% | 10 μm | 0.1 g B1 (5%), 0.2 g C1, 0.02 g | 299.1 | −38.7% | 46 | 29% |
| | alumina | | C2, 0.85 g A1, 0.85 g A4, | | | | |
| | oxide | | 0.015 g D1, 2 mm, | | | | |
| C-2 | 20% | 10 μm | 0.4 g B1 (20%), 0.2 g C1, | 129.2 | −73.5% | 41 | 37% |
| | alumina | | 0.02 g C2, 0.7 g A1, 0.7 g A4, | | | | |
| | oxide | | 0.015 g D1, 2 mm, | | | | |
| C-3 | 20% | 5 μm | 0.4 g B2 (20%), 0.2 g C1, | 3.8 | −99.2% | 38 | 42% |
| | alumina | | 0.02 g C2, 0.7 g A1, 0.7 g A4, | | | | |
| | nitride | | 0.015 g D1, 2 mm | | | | |
| C-4 | 20% | 5 μm | 0.4 g B3 (20%), 0.2 g C1, | 3.1 | −99.4% | 36 | 45% |
| | silicon | | 0.02 g C2, 0.7 g A1, 0.7 g A4, | | | | |
| | carbide | | 0.015 g D1, 2 mm | | | | |
| I-2 | 20% | 150 μm | 0.4 g B4 (20%), 0.2 g C1, | 425.3 | −12.8% | 43 | 34% |
| | glass | | 0.02 g C2, 0.7 g A1, 0.7 g A4, | | | | |
| | bead | | 0.015 g D1, 2 mm | | | | |

As can be seen from Table I, inventive devices I-1 and I-2, which include a thermally conductive additive, afford about 30% better heat conductivity relative to the comparison device C-1. However, the luminance efficiency of the device is decreased by using an additive. This loss can be minimized by using an additive composed of transparent material such as glass. Comparison devices C-2 through C-4 have the thermal additive present at a high level (20%) and afford excellent heat conductivity; however, there is a very large loss of luminance efficiency.

### TUBULAR SHELL EXAMPLES

### Comparative Example C-5

### Preparation of a Tubular Shell Without a Thermally Conductive Additive

Component C1 (50 g) was added to 50 g of Component E1, and mixed. The mixture was added to 400 g of Component A1 and 6 g of Component D2, and mixed by roller. The final composite (which did not contain Component B) was added to an extruder and phosphor/silicone tubing was extruded. This afforded a tubular shaped shell having a wall thickness of 0.5 mm, and an inner diameter of 1.5 mm. The tubing was cured at 300° C. for 60 s, then post-cure at 180° C. for 2 h. This process afforded a tubular-shaped shell including a wavelength conversion layer.

### Inventive Example I-3

### Preparation of a Tubular Shell with a Thermally Conductive Additive

Component C1 (50 g) and 5 g of Component B1 were added to 50 g of Component E1, and mixed. The mixture was added to 400 g of Component A1 and 6 g of Component D2, and mixed by roller. The final composite was added to an extruder and extruded in the shape of a tube. The tubing was cured at 300° C. for 60 s, then post-cure at 180° C. for 2 h. This process afforded a tubular shaped phosphor/silicone shell having a wall thickness of 0.5 mm, and an inner diameter of 1.5 mm.

### Inventive Examples I-4

### Preparation of a Tubular Shell with a Thermally Conductive Additive

Component C1 (100 g) and 30 g of Component B1 were added to 50 g of Component E1, and mixed. The mixture was added to 500 g of Component A1 and 6 g of Component D2, and mixed by roller. The final composite was added to an extruder and extruded in the shape of a tube. The tubing was cured at 280° C. for 60 s, then post-cure at 180° C. for 2 h. This process afforded a tubular shaped phosphor/silicone shell having a wall thickness of 0.8 mm, and an inner diameter of 2 mm.

### Inventive Example I-5

### Preparation of a Tubular Shell with Two Wavelength Conversion Layers and a Thermally Conductive Additive

Component C1 (45 g) and 5 g of Component B2 were added to 30 g of Component of E2, and mixed. The mixture was added to 300 g of Component A1 and 6 g of Component D2, and mixed by roller to afford Composite 1. A second composite was formed by combining 5 g of Component C3, 0.5 g of Component B2, and 10 g of Component E2, and mixing. The mixture was added to 100 g of Component A1 and 2 g of Component D2, and mixed by roller to afford Composite 2. Composites 1 and 2 were added to separate inlet ports of an extruder. The composites were extruded in the shape of a tube having concentric layers. This afforded a tubular shaped shell having two layers and a total wall thickness of 0.4 mm and an inner diameter of 1.2 mm. The inner layer was formed from Composite 2 and had a thickness of 0.15 mm. The outer layer was formed from Composite 1 and had a thickness of 0.25 mm. The tubing was cured at 250° C. for 60 s, then post-cure at 180° C. for 1.5 h. This process afforded a tubular-shaped shell including two wavelength conversion layers.

In the most preferred method of claim 13, the shell is cured for 40 to 60 seconds, and/or the shell is post-cured for 1.5 to 2.5 hours. In the most preferred embodiment of claim 1, the shell is extrusion molded into a tubular shape. In the most preferred second method of claim 20, the polymeric tube comprises polycarbonate, polyvinylchloride, polypropylene, polyethylene, or silicone rubber.

The invention has been described in detail with particular reference to certain preferred embodiments thereof, but it will be understood that variations and modifications can be effected within the spirit and scope of the invention.

1. A light-emitting element comprising a transparent tubular-shaped shell surrounding a cavity, wherein the cavity includes at least one light source optically coupled to the tubular shell, and wherein the tubular-shaped shell comprises a wavelength conversion layer.

2. The element of claim 1, wherein the light source comprises at least one light-emitting diode mounted on a support.

3. The element of claim 1, wherein at least one of the shell or the wavelength conversion layer comprises silicone.

4. The element of claim 1, wherein the wavelength conversion layer comprises a thermally conductive additive.

5. The element of claim 4 wherein the thermally conductive additive comprises at least one of a transparent, material, a translucent material, glass or quartz.

6. The element of claim 4 wherein the thermally conductive additive comprises aluminum oxide, aluminum nitride, silicon carbide or combinations thereof at a level of less than 20 wt. % of the wavelength conversion layer.

7. The element of claim 1, wherein the wavelength conversion layer is extrusion molded into a tubular shape.

8. The element of claim 1 comprising at least two wavelength conversion layers co-extrusion molded into concentric tubes.

9. The element of claim 1 wherein the shell includes at least one substrate.

10. The element of claim 9, wherein at least one wavelength conversion layer is coated on the substrate.

11. The element of claim 1, wherein the wavelength conversion layer includes light scattering particles.

12. The element of claim 1, wherein the cavity includes a transparent material that optionally can be cured.

13. A method of preparing the element of claim 1 comprising the steps of:
a) providing Component A comprising a first organopolysiloxane siloxane including a first reactive group; and at least a second organopolysiloxane including a second reactive group;
b) providing Component B comprising a thermally conductive additive;
c) providing Component C comprising at least one phosphor material;
d) providing Component D comprising a curing agent;
e) providing Component E comprising an organopolysiloxane having a viscosity in the range of 200 to 80000 mPa·s;
f) combining and mixing Components A-E to form a composite;
g) extruding the composite to form a tubular shaped shell having an internal cavity;
h) curing the shell and causing the first reactive group to react with the second reactive group;
i) post-curing the shell;
j) allowing the shell to cool and then inserting at least one light source into the cavity of the shell to afford a light-emitting element.

14. The method of claim 13 wherein the shell is cured at a temperature between 200 to 300° C. for 10 to 90 seconds.

15. The method of claim 13 wherein the shell is post-cured at a temperature between 100 to 250° C. for 1 to 5 hours.

16. The method of claim 13 wherein the composite is formed by combining and mixing Component B, Component C, and Component E to form a first mixture, and combining and mixing the first mixture with Components A and Component D to form the composite.

17. The method of claim 13 wherein the first mixture comprises Component C and Component E in the ratio of (1):(x) by weight, wherein x is a value between 0.2 and 1.0.

18. The method of claim 13 wherein a first composite is formed according to steps a) through f) comprising a first phosphor material; and wherein a second composite is formed according to steps a) through f) comprising a second phosphor material; and wherein the first and second composites are coextruded to form a tubular shaped shell having concentric layers containing the first phosphor material in the inner layer and the second phosphor materials in the outer layer, and wherein a light-emitting element is formed from the shell according to steps h) through j).

19. The method of claim 18 wherein the first phosphor emits red light and the second phosphor emits yellow light.

20. A method of preparing a substrate, which includes a wavelength conversion layer, comprising the steps of:
a) forming a first mixture by combining particles of a phosphor material and silicone fluid in the ratio of (1):(x) by weight, wherein x is a value between 0.2 and 1.0;
b) passing a polymeric tube through the mixture thereby coating the tube with a layer of the first mixture and thereby forming a tubular shell;
c) curing the substrate by heating it at a temperature between 200 to 300° C. for 10 to 60 minutes;
e) post-curing the substrate by heating it at a temperature between 150 to 250° C. for 1 to 5 hours;
f) allowing the substrate to cool to ambient temperature.
